(19) United States
(12) Patent Application Publication
(10) Pub. No.: US 2006/0163783 A1
(43) Pub. Date: Jul. 27, 2006

(54) Elastic deformable cushion

(76) Inventor: Teng Jen Yang, Wufeng Shiang (TW)

Correspondence Address: CHARLES E. BAXLEY, ESQ., 90 JOHN STREET, THIRD FLOOR, NEW YORK, NY, 10038, US

(21) Appl. No.: 11/389,755

(22) Filed: Mar. 27, 2006

Related U.S. Application Data
(63) Continuation-in-part of application No. 10/881,083, filed on Jul. 1, 2004.

(51) Int. Cl. F16M 1/00

(52) U.S. Cl. 267/136

(57) ABSTRACT

An elastic deformable cushion comprises: an elastoplastic curved piece made of elastoplastic material, and at least two elastoplastic ribs. At least two non-spiral grooves are formed in a periphery wall of the elastoplastic curved piece, and the non-spiral grooves are not in communication with and separated from one another. The at least two elastoplastic ribs are formed in the at least two non-spiral grooves of the elastoplastic curved piece, the elastoplastic ribs are integral with the elastoplastic curved piece, and each of the two elastoplastic ribs have a curved portion.

This application is a continuation of part of U.S. patent application Ser. No. 10/881,083 filed on Jul. 1, 2004, which claims the benefit of the earlier filing date.

### BACKGROUND OF THE INVENTION

1. Field of the Invention

The present invention relates to an elastic deformable cushion, and more particularly to an elastic deformable cushion that is integrally formed by soft elastoplastic rib and hard elastoplastic rib piece, through this structure, the damper performance and elastic recovery function of the elastic deformable cushion is improved.

2. Description of the Prior Arts

Shock-absorbing structure is widely used, such as on the machine, the shoes and the article for daily use. U.S. Pat. No. 6,749,187 discloses a conventional shock-absorbing structure (as shown in FIG. 1), which includes elastoplastic continuous spiral member 10 and elastoplastic spiral strip 11. The elastoplastic spiral member 10 and the elastoplastic spiral strip 11 are installed in the sole of a sneaker. The connecting portion of the elastoplastic spiral member 10 and that of the elastoplastic spiral strip 11 can be integrally connected together. The elastoplastic spiral member 10 is formed in the shape of a spiral spring. The elastoplastic spiral strip 11 is formed with multi layers of arc-curved portions 12 corresponding to the elastoplastic spiral member 10, and each layer of the arc-curved portions 12 are helically connected to each other. The elastoplastic spiral strip 11 is fixed in the elastoplastic spiral member 10. However, this conventional elastic cushion still has some disadvantages as follows:

First, the elastoplastic spiral member 10 and the elastoplastic spiral strip 11 must be combined together and produced in a helical manner, however, the production cost of such spiral shock-absorbing structure is pretty high.

Second, the shape of the elastoplastic spiral member 10 and the elastoplastic spiral strip 11 has been confined to the helical cylinder, thereby, the applicability of the conventional elastic cushion is limited.

The present invention has arisen to mitigate and/or obviate the afore-described disadvantages.

### SUMMARY OF THE INVENTION

The primary object of the present invention is to provide an elastic deformable cushion, an elastoplastic rib of which is provided at the bearing surface with a curved portion so as to improve the compressive rigidity. On the vertical bearing surface of the elastoplastic rib piece is provided with multi layers of arc-curved portion for improving the buffering effect.

The secondary object of the present invention is to provide an elastic deformable cushion, wherein an elastoplastic curved piece made of elastoplastic material, at least two non-spiral grooves are formed in a periphery wall of the elastoplastic curved piece, the non-spiral grooves are not in communication with and separated from one another, and the elastoplastic ribs are formed in the at least two non-spiral grooves. In this case, the elastic deformable cushion in accordance with the present invention can be easily produced, and the resultant production cost will be reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a structural perspective view of a conventional elastic deformable cushion;

FIG. 2 is a horizontal cross sectional view of an elastic deformable cushion in accordance with a first embodiment of the present invention;

FIG. 3 is a vertical cross sectional view of an elastic deformable cushion in accordance with a first embodiment of the present invention;

FIG. 4 is an operational cross sectional view of an elastic deformable cushion in accordance with a first embodiment of the present invention, which shows the elastic deformable cushion is being compressed by a force;

FIG. 5 is a perspective view of an elastic deformable cushion in accordance with a first embodiment of the present invention;

FIG. 6 is an operational cross sectional view of an elastic deformable cushion in accordance with a first embodiment of the present invention;

FIG. 7 is a perspective cross sectional view of an elastic deformable cushion in accordance with a second embodiment of the present invention;

FIG. 8 is an operational cross sectional view of an elastic deformable cushion in accordance with a third embodiment of the present invention, which shows the elastic deformable cushion is being compressed by a force;

FIG. 9 is a side view of an elastic deformable cushion in accordance with a fourth embodiment of the present invention;

FIG. 10 is a side view of an elastic deformable cushion in accordance with a fifth embodiment of the present invention;

FIG. 11 is a perspective cross sectional view of an elastic deformable cushion in accordance with a fourth embodiment of the present invention;

FIG. 12 is a side view of an elastic deformable cushion in accordance with a sixth embodiment of the present invention;

FIG. 13 is an operational view of an elastic deformable cushion in accordance with an embodiment of the present invention;

FIG. 14 is a partial amplified view of an elastic deformable cushion in accordance with the present invention;

FIG. 15 is an operational view of an elastic deformable cushion in accordance with an embodiment of the present invention, wherein the elastoplastic rib piece is formed with holes;

FIG. 16 is another partial amplified view of an elastic deformable cushion in accordance with the present invention.

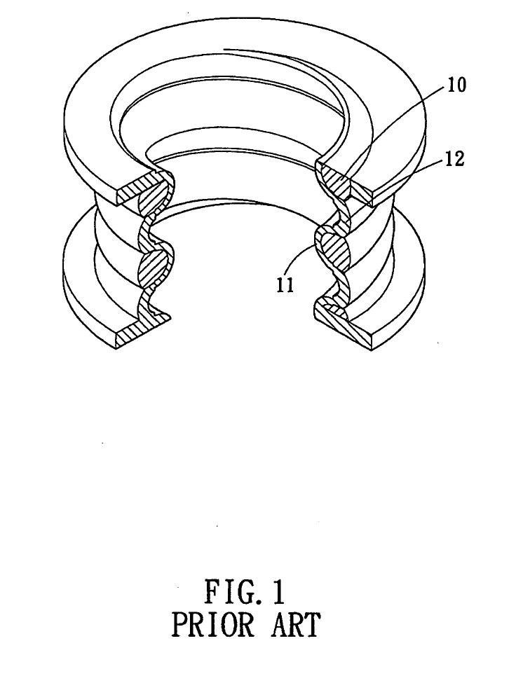

### DETAILED DESCRIPTION OF THE PREFERRED EMBODIMENTS

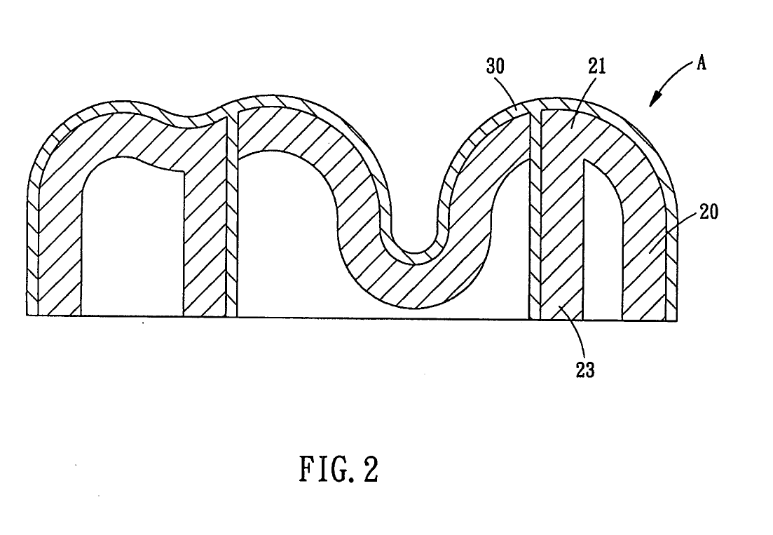

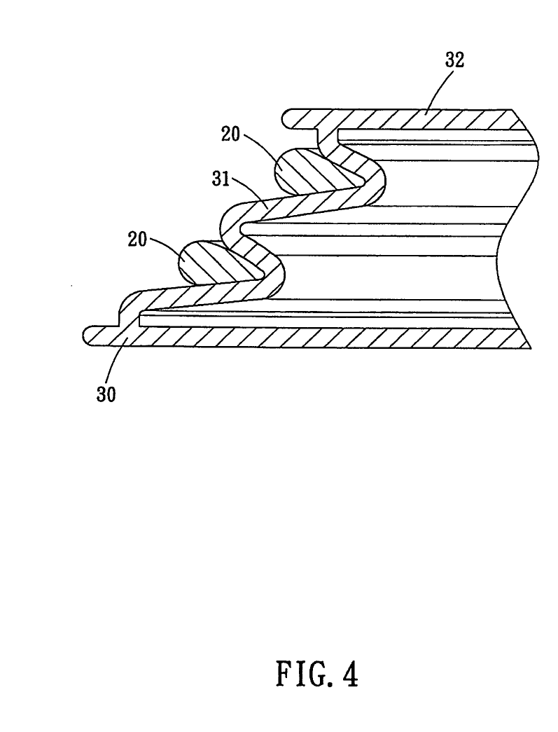

Referring to FIGS. 2-4, an elastic deformable cushion A is shown and generally including a plurality of elastoplastic ribs 20 and an elastoplastic curved piece 30, both of which are to be disposed on a bearing surface of a shock-absorb object (such as: sole and the buffering equipment). The elastic deformable cushion is made by plastic ejection molding (or reimplantation), therefore the plastic connecting portion of the respective elastoplastic ribs 20 and that of the elastoplastic curved piece 30 are integrally and firmly connected to each other.

The elastoplastic ribs 20 are separated from one another by a buffering distance 22 and are stacked one on top of another (not in a helical manner). Each of the elastoplastic ribs 20 is formed with a curved portion 21 which is U-shaped correspondingly to the bearing surface. The curved portion 21 is provided with an outward protruded supporting portion 23.

The elastoplastic curved piece 30 is a thin piece made of hard elastoplastic material. A plurality of non-spiral grooves 34 are parallel to one another and are formed in the periphery wall of the elastoplastic curved piece 30, and the non-spiral grooves 34 are not in communication with and are separated from one another. The cross sectional surfaces 31 of the non-spiral grooves 34 are continuously connected in a wavy fashion. A top surface 32 and a bottom surface 33 of the elastoplastic rib-piece 30 are formed as a bearing surface. The elastoplastic ribs 20 are formed in the non-spiral grooves 34 of the elastoplastic curved piece 30. The elastoplastic curved piece 30 is integrally formed with a side of the respective elastoplastic ribs 20 (including the curved portions 21 and the supporting portions 23).

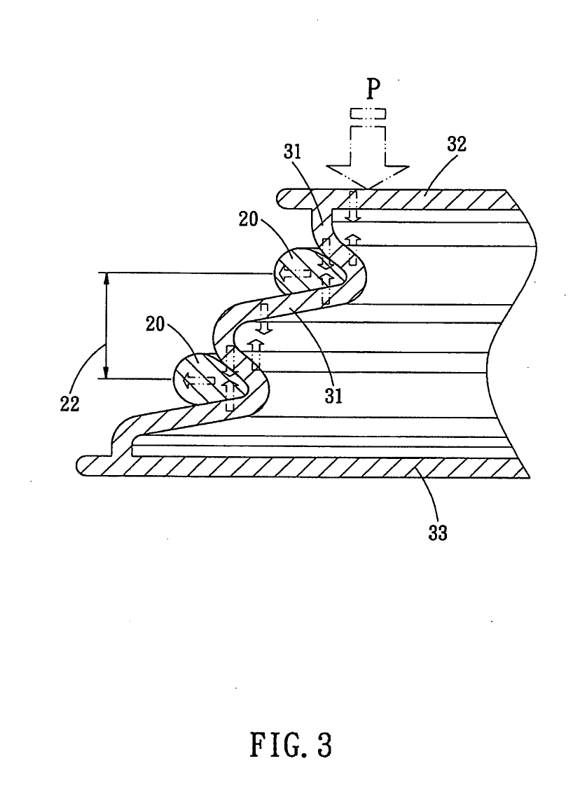

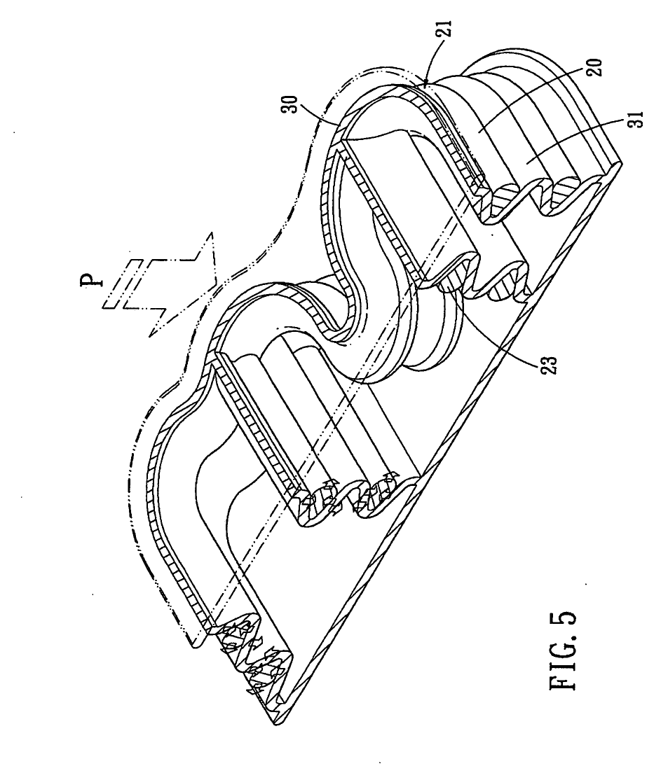

Referring to FIGS. 3 and 5, when the elastic deformable cushion A is compressed by an even pressure force P from the top surface, the top surface 32 of the elastoplastic curved piece 30 synchronously bears the pressure force P, then the pressure force P is transmitted to the first layer of the elastoplastic curved piece 30 and the top elastoplastic ribs 20. The deformation capability of the top elastoplastic ribs 20 and the buffering distance 22 can provide adequate deforming space (the first load-carrying compressive space) for the respective cross sectional surfaces 31 of the elastoplastic curved piece 30, that is, the cross sectional surfaces 31 of the elastoplastic curved piece 30 will be deformed and pressed against one another in the buffering distance 22. The rest layers, after the first layer, of the elastoplastic curved piece 30 and the rest elastoplastic ribs 20 will repeat the operation as the first layer of the elastoplastic curved piece 30 and the first elastoplastic ribs 20 do, so as to produce adequate deforming space (more than two load-carrying compressive spaces). Thus, the respective load-carrying compressive spaces can disperse and absorb the pressure force P.

On the other hand, the plural curved portions 21 can be used to improve the compressive rigidity of the elastoplastic ribs 20, and the curved portions 21 on the bearing surface and the supporting portions 23 are used to maintain the predetermined shape of the elastic deformable cushion A (to prevent the permanent deformation of the elastic deformable cushion A). At this moment, not only the raw material of the elastoplastic ribs 20 and the elastoplastic curved piece 30 can produce recovering elastic force, but also the curved portions 21 and the supporting portions 23 of the elastoplastic ribs 20 can generate an inward pulling force. Moreover, the plural cross sectional surfaces 31 of the elastoplastic curved piece 30 will produce a recovering force to counter the external bearing. Thereby, the present invention can produce multiple recovering forces to counter the deformation, through this way, the pressure force P is effectively absorbed. In addition, the elastoplastic ribs 20 and the elastoplastic curved piece 30 can have various shapes, therefore, the elastic cushion in accordance with the present invention has a wide applicability.

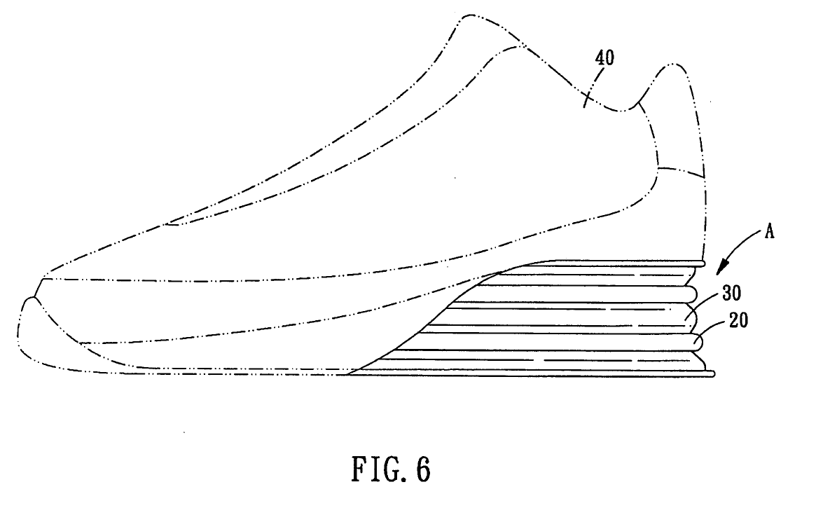

It will be noted that the elastoplastic ribs 20 and the elastoplastic curved piece 30 can produce a resistant force corresponding to an uneven pressure force P exerted on any side of the elastic deformable cushion (for example: the pressure force P is exerted on the right side, then a resistant force will be synchronously generated on the left side). Thereby, when the elastic deformable cushion is subject to a deflecting pressure force P, other portions of the elastic deformable cushion A in accordance with the present invention can synchronously produce a recovering force to balance the deflecting pressure force P. On the other hand, when an uneven pressure force is exerted on the elastic deformable cushion, the elastoplastic ribs 20 and the elastoplastic curved piece 30 will be synchronously subject to a deflecting pressure force. At this moment, the buffering distance 22 at a side of the elastoplastic ribs 20 will be shortened after being compressed, while the buffering distance at another side will be lengthened. However, the cross sectional surfaces 31 of the elastoplastic curved piece 30 also will be shortened and lengthened along with the deformation of the buffering distance 22. In this case, not only the elastoplastic ribs 20 and the elastoplastic curved pieces 30 at the compression side of the elastic deformable cushion will be synchronously subject to the deflecting press force P, but also the cross sectional surfaces 31 of the elastoplastic curved piece 30 at another side of the elastic deformable cushion will assist the elastoplastic ribs 20 produce a supporting force to counter the deformation. The curved portions 21 and the supporting portions 23 of the elastoplastic ribs 20 can disperse the pressure force over a larger area of the elastic deformable cushion A. Through this way, not only the hard elastoplastic curved piece 30 can effectively balance the pressure force P and protect the soft elastoplastic ribs 20, but also the supporting portions 23, the cross sectional surfaces 31 and the curved portions 21 are able to produce a balance effect by dispersing the deflecting pressure force. Such that the abruption and dislocation of the hard elastoplastic curved piece 30 can be effective prevented. A first preferred embodiment in accordance with the present invention is shown in FIG. 6, in which, the elastic deformable cushion in accordance with the present invention is placed into the heel of a sneaker 40 for shock-absorbing purpose.

It is to be noted that the top surface 32 and the bottom surface 33 of the elastoplastic curved piece 30 can be formed on the top layer and the lowest layer of the elastoplastic ribs 20. Furthermore, the elastoplastic rib and the top and the bottom surfaces of the elastoplastic curved piece can be formed with curved surface corresponding to the to-be-loaded object.

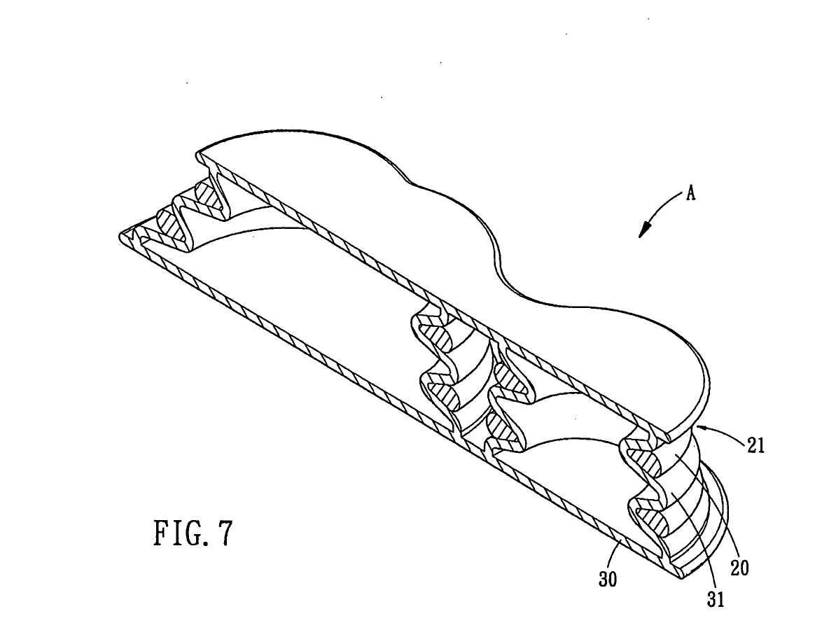

A second preferred embodiment of the present invention is shown in FIG. 7, in which, the supporting portions 23 of the elastoplastic ribs 20 can be omitted, or some layers of the elastoplastic curved piece 30 can be made of soft material so as to be combined with the corresponding layers of the elastoplastic ribs 20.

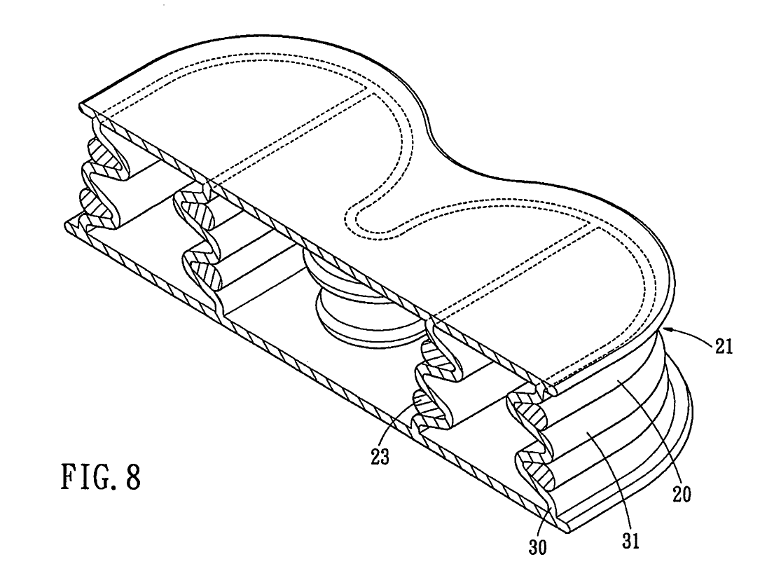

Referring to FIG. 8, which shows a third embodiment in accordance with the present invention, wherein the curvature and the angle of the curved portions 21 of the elastoplastic ribs 20 can be set according to the user's needs. For example, the curved portions 21 can be U-shaped, semi-circular-shaped or elliptical-shaped.

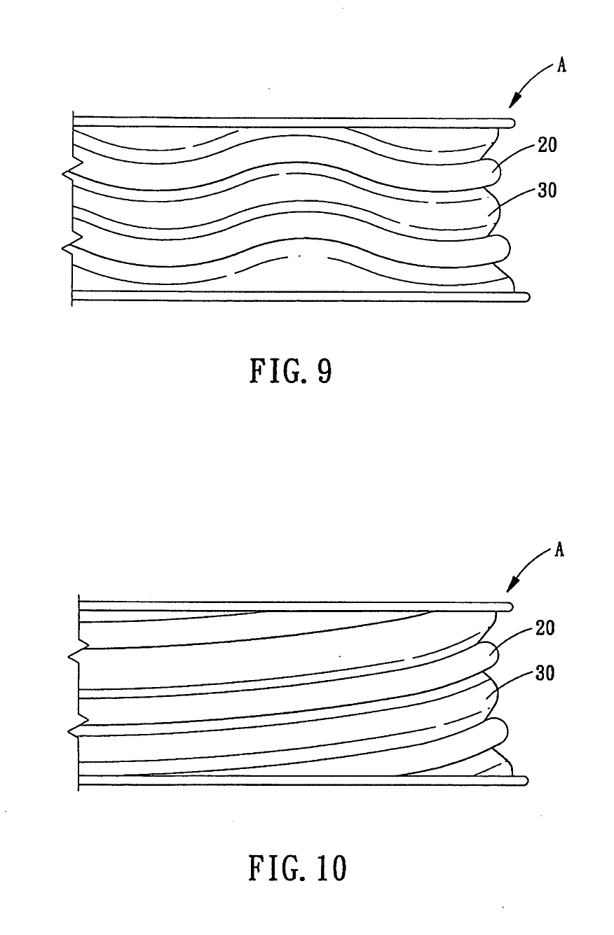

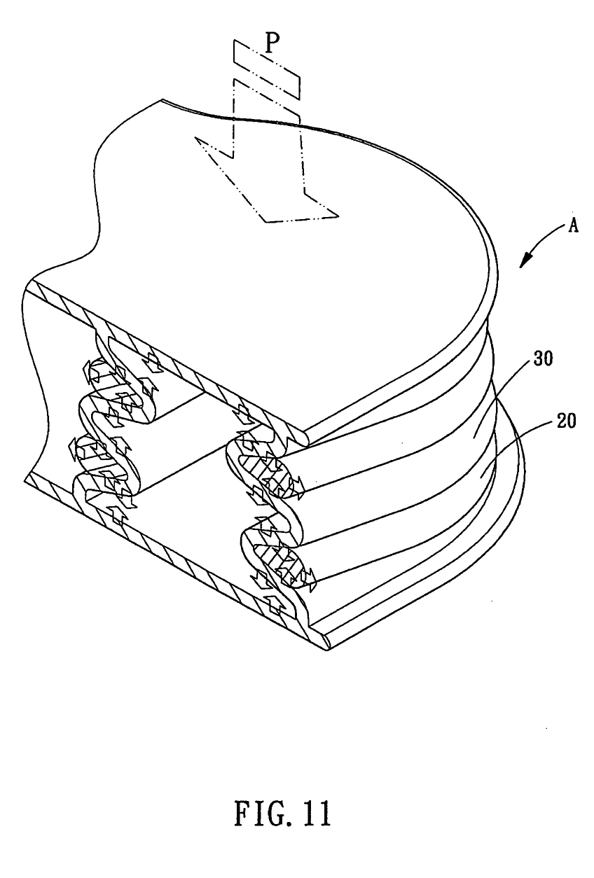

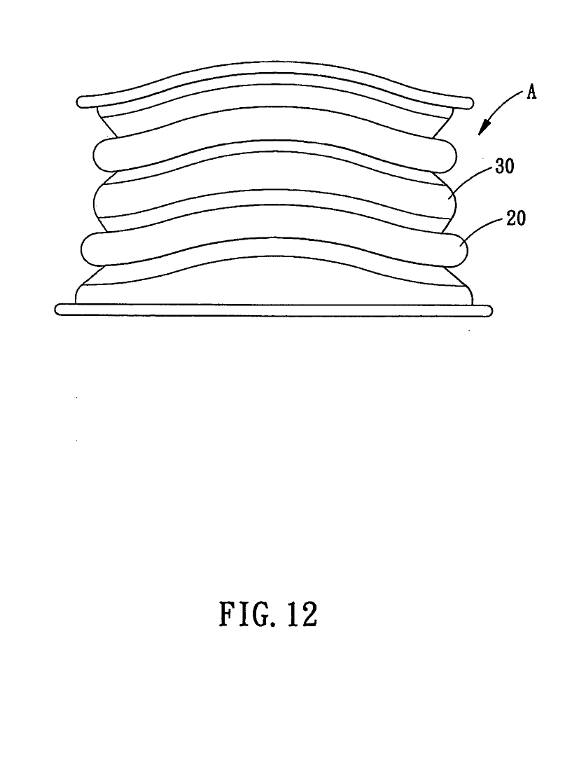

The bearing surface corresponding to the elastoplastic ribs 20 is not limited to horizontal surface, it also can be wave-shaped bearing surface (as shown in FIG. 9), inclined bearing surface (as shown in FIGS. 10 and 11) or slope-shaped bearing surface (as shown in FIG. 12). Not only the curved portions 21 has a force-bearing function, but also the curve-shaped base body of the elastoplastic ribs 20 can produce a strong supporting force and can effectively disperse the pressure force P.

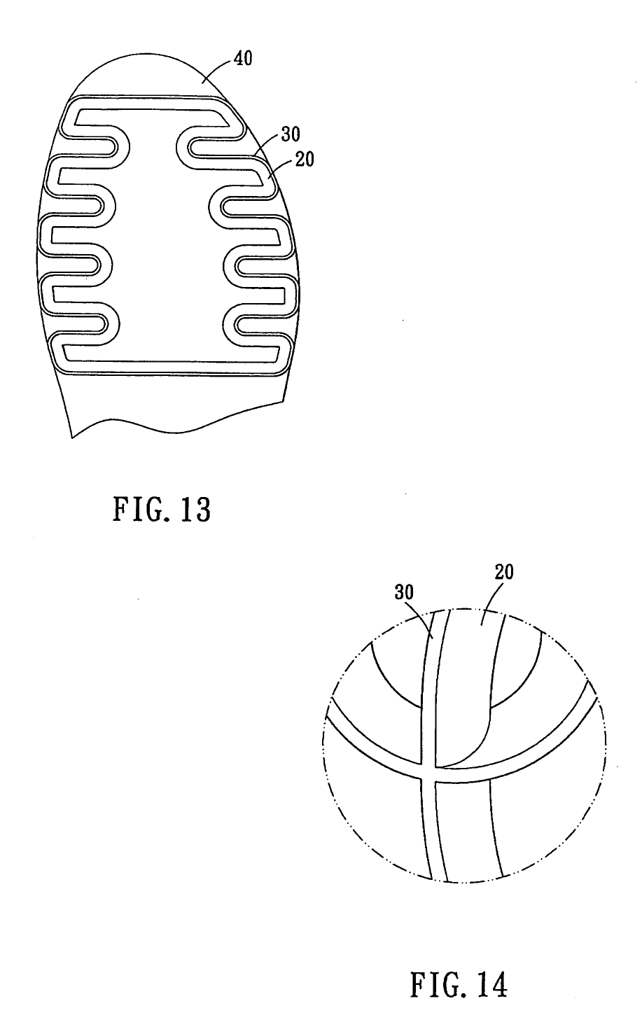

Referring to FIG. 13, the elastic cushion also can be placed in front portion of the sole of the sneaker 40. As shown in FIG. 14, the elastoplastic ribs 20 and the elastoplastic curved piece 30 can be crosswise arranged.

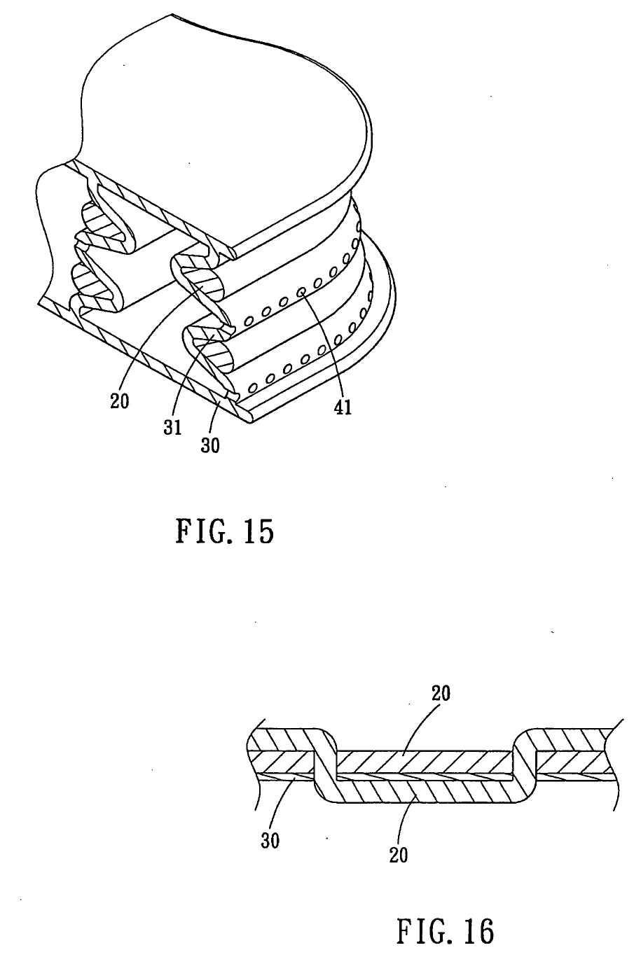

Referring to FIG. 15, the elastoplastic ribs 20 and the elastoplastic curved piece 30 in accordance with the present invention can be formed with holes 41 or grooves, so as not only to reduce the weight but also to adjust the damper effect of the elastic cushion.

As shown in FIG. 16, the plural elastoplastic ribs 20 can be interlaced with each other, so as to improve the structural strength of the elastic cushion.

While we have shown and described various embodiments in accordance with the present invention, it should be clear to those skilled in the art that further embodiments may be made without departing from the scope of the present invention.

What is claimed is:

1. An elastic deformable cushion comprising:
an elastoplastic curved piece made of elastoplastic material, at least two non-spiral grooves formed in a periphery wall of the elastoplastic curved piece, and the non-spiral grooves being not in communication with and separated from one another; and
at least two elastoplastic ribs formed in the at least two non-spiral grooves of the elastoplastic curved piece, the elastoplastic ribs being integral with the elastoplastic curved piece, and each of the two elastoplastic ribs having a curved portion.

2. The elastic deformable cushion as claimed in claim 1, wherein the non-spiral grooves in the elastoplastic curved piece are parallel to one another.

3. The elastic deformable cushion as claimed in claim 1, wherein the at least two elastoplastic ribs are separated from each other by a buffering distance, cross sectional surfaces of the at least two non-spiral grooves are continuously connected in a wavy fashion, when the elastic deformable cushion is compressed, the cross sectional surfaces of the at least two non-spiral grooves will be deformed and pressed against each other within the buffering distance.

4. The elastic deformable cushion as claimed in claim 1, wherein an outward protruded supporting portion is formed on the curved portion of each of elastoplastic ribs.

5. The elastic deformable cushion as claimed in claim 2, wherein an outward protruded supporting portion is formed on the curved portion of each of elastoplastic ribs.
